(19) United States
(12) Patent Application Publication
(10) Pub. No.: US 2006/0075360 A1
(43) Pub. Date: Apr. 6, 2006

(54) Dynamic highlight prompting apparatus and method

(75) Inventor: Craig S. Bixler, Saint Charles, IL (US)

Correspondence Address: BAKER & HOSTETLER LLP;Washington Square, Suite 1100, 1050 Connecticut Avenue, N.W., WASHINGTON, DC, 20036, US

(73) Assignee: Edwards Systems Technology, Inc.

(21) Appl. No.: 10/967,206

(22) Filed: Oct. 19, 2004

Related U.S. Application Data
(60) Provisional application No. 60/615,204, filed on Oct. 4, 2004.

(51) Int. Cl. G06F 17/00

(52) U.S. Cl. 715/805

(57) ABSTRACT

Dynamic Highlight Prompting provides graphical interface screens that have moderate complexity, and that selectively highlight the most likely selections at each step in multistep processes. Dynamic Highlight Prompting allows a novice or occasional user to follow an understandable sequence, while allowing a proficient user to choose valid, non-highlighted selections to bypass inefficient operations.

### CROSS-REFERENCE TO RELATED APPLICATIONS

This application claims priority to provisional U.S. patent application entitled, “DYNAMIC HIGHLIGHT PROMPTING APPARATUS AND METHOD,” filed Oct. 4, 2004, having a Ser. No. 60/615,204, the disclosure of which is hereby incorporated by reference in its entirety.

### FIELD OF THE INVENTION

The present invention relates generally to user interface software for use in computing equipment. More particularly, the present invention relates to dynamic modification of displayed user presentations for successive prompt screens.

### BACKGROUND OF THE INVENTION

It is known in user interface software to employ a variety of methods for generating, reading, and altering database entries, writing single-purpose software routines, creating initialization files, and concatenating other blocks of computer-readable as well as human-readable information. Greater or lesser amounts of automation may be employed when providing software tools that allow novice and occasional users as well as expert users to use computers as aids in the performance of such tasks. Automation tools are often provided in an attempt to avoid errors, reduce the level of proficiency required, and speed user completion of tasks.

It is further known in computer-based user interface software to provide automation tools known as wizards to guide users through sequences of steps needed to perform functions with which users may be relatively unfamiliar. A typical wizard as heretofore conceived might use a succession of screen displays to guide a user through such tasks as the creation or alteration of a schedule or a client entry, the addition of a new computer to an existing network, or the replacement of a hardware device or a device driver in a computer, to site a few examples. Each of the screens making up a wizard might include an explanatory text block, for example, and one or a few items such as simulated pushbuttons, blanks into which information can be typed, pulldown lists from which to select an item, and the like.

In lieu of using a wizard, other known methods include reading, writing, or editing a standalone data file in which individual variables and their arguments are listed, directly accessing fields in a database to find or enter data, directly searching storage media and hardware registers within a computer to discover existing resources using batch files or equivalent programs, and other data processing methods.

These and other implementations can meet operational requirements, but can exhibit significant shortcomings. For example, in directly writing to a file or making entries into a database, errors are readily generated and can be difficult to identify, while making revisions can be time consuming or uncertain.

In using a wizard, if numerous options are available, choices can be difficult to present in a systematic way. As a result, the novice or occasional user may work through a succession of simple screens repeatedly and may never master the sequence of steps that the author of the wizard intended the user to perform to lead reliably to success. If presented with a complex screen rather than a succession of simple screens, the novice or occasional user may become confused or overburdened. A proficient user, in contrast, may find a sequence that is difficult for the novice to be instead tedious, once all of the steps are well known.

Accordingly, it is desirable to provide interactive user interface software that balances simplicity of use, speed, obviousness, convenient verification, and protection against invalid interaction.

### SUMMARY OF THE INVENTION

The above and other features and advantages are achieved in some embodiments by a novel prompting methodology, as herein disclosed. The prompting methodology employs dynamic highlighting to guide the user and adaptive weighting to adapt the recommended options to the experience level of the user at each step.

In accordance with one embodiment of the present invention, a method of displaying and processing information includes the steps of presenting a display image on a display component of an interface device, wherein the display image includes at least two display elements, and wherein the alterable display attribute assigned to each display element is selected from the group consisting of a selectable, non-preferred element, a selectable, preferred element, a nonselectable element, and an informational element, identifying within the display image a selectable, non-preferred element by a first style of display element marking, identifying within the display image a selectable, preferred element by a second style of display element marking, identifying within the display image a non-selectable element by a third style of display element marking, and identifying within the display image an informational element by a fourth style of display element marking.

In accordance with another embodiment of the present invention, a computer readable medium with program instructions for displaying and processing information includes the instructions for presenting a display image on a display component of an interface device whereupon are displayed at least two display elements, identifying within the display image a selectable, non-preferred display element by a first style of display element marking, identifying within the display image a selectable, preferred display element by a second style of display element marking, identifying within the display image a non-selectable display element by a third style of display element marking, and identifying within the display image an informational display element by a fourth style of display element marking.

In accordance with yet another embodiment of the present invention, an information acquisition, maintenance, and display system includes a processing device, an input/output interface unit for the processing device, an information storage and retrieval unit providing modifiable record keeping for the processing device, and a processor-based instruction sequence actuating the processing device to provide control of the interface unit and the information storage and retrieval unit.

In accordance with still another embodiment of the present invention, an information acquisition, maintenance, and display system includes means for displaying, entering, selecting, and modifying data in a data management process, means for presenting a plurality of data elements, wherein a data element has any of a plurality of values assigned to an attribute thereof, using a data display device capable of providing at least a two-dimensional display image to represent the plurality of data elements, means for accepting input from a data input apparatus, means for identifying, within the display image, a selectable, non-preferred display element by a first style of display element marking, means for identifying within the display image a selectable, preferred display element by a second style of display element marking, means for identifying within the display image a non-selectable display element by a third style of display element marking, means for identifying within the display image an informational display element by a fourth style of display element marking, and means for storing, modifying, and retrieving data in a data management process.

There have thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be used as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a state diagram for an embodiment of the invention.

FIG. 2 is a first screen display for an embodiment of the invention.

FIG. 3 is a second screen display for an embodiment of the invention.

FIG. 4 is a third screen display for an embodiment of the invention.

FIG. 5 is a fourth screen display for an embodiment of the invention.

FIG. 6 is a fifth screen display for an embodiment of the invention.

FIG. 7 is a sixth screen display for an embodiment of the invention.

FIG. 8 is a seventh screen display for an embodiment of the invention.

FIG. 9 is a eighth screen display for an embodiment of the invention.

FIG. 10 is a ninth screen display for an embodiment of the invention.

FIG. 11 is an alternative fifth screen display for an alternative embodiment of the invention.

FIG. 12 is an alternative sixth screen display for an alternative embodiment of the invention.

### DETAILED DESCRIPTION

The invention will now be described with reference to the drawing figures, in which like reference numerals refer to like parts throughout. A preferred embodiment in accordance with the present invention provides a software interface that guides a user through a series of steps within at least one comparatively information-rich screen display. The software indicates, by highlighting of the most likely options at each step, what the expected sequence and range of selections are, while showing but leaving unhighlighted those options which are possible but unlikely. Selection of items that have no meaning as options at a step can be positively prevented. The dynamic character of the software is further enhanced by permitting a learning function, whereby the presentation of highlighted options by the software can adapt to individual users or classes of users based on their demonstrated level of proficiency.

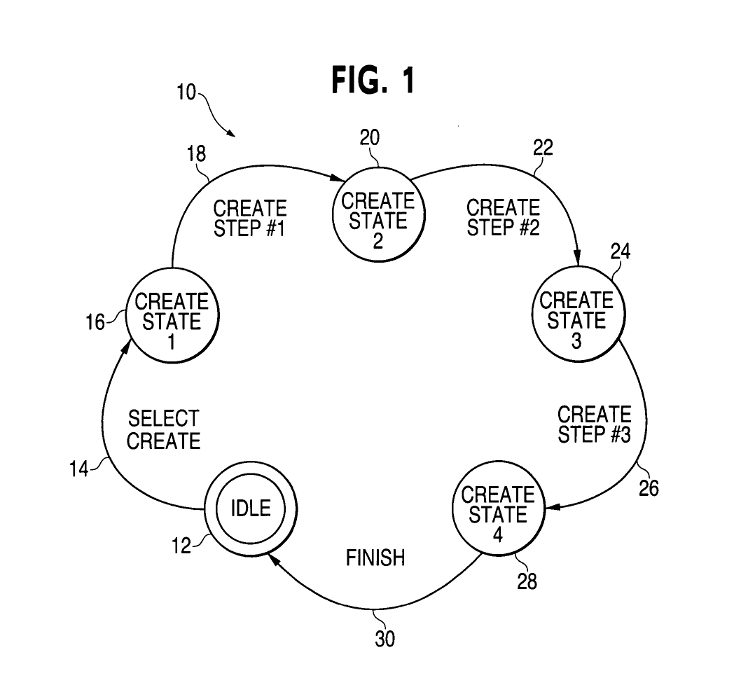

FIG. 1 is a state transition diagram 10 in which a predetermined four-step sequence is shown. From an IDLE state 12, selection 14 of a CREATE activity advances the software to a CREATE State #1 16 in which a set of selectable elements is presented, of which a subset is highlighted. The highlighting is intended to imply that the user should preferentially choose from among the elements in the highlighted subset. Selection 18 of any valid element, highlighted or unhighlighted, in the CREATE State #1 16 advances the software to a CREATE State #2 20 in which a second subset of the set of selectable elements is highlighted, once again implying that the user should preferentially choose from among the highlighted elements of the new subset. This process repeats with selection 22 leading to CREATE State #3 24 and selection 26 leading to CREATE State #4 28. In the case shown, the final selection 30 completes the sequence, leading back to IDLE 12. In other cases, completion of a final selection 30 may instead lead to return to a calling routine, for example.

In each of the above states, elements can be displayed that are not selectable during the current state, but can be selectable in another software state. Such elements can likewise be distinctively marked, using a process such as “graying out,” known to most users of graphical user interface (GUI)-based software. In “graying out” of elements, reduction of the level of contrast between the nonselectable elements and the background, for example, can be employed to decrease the extent to which the elements resemble buttons. Similarly, informational data, that is, display elements that are never selectable, can be displayed, such as by assigning such elements another distinctive appearance.

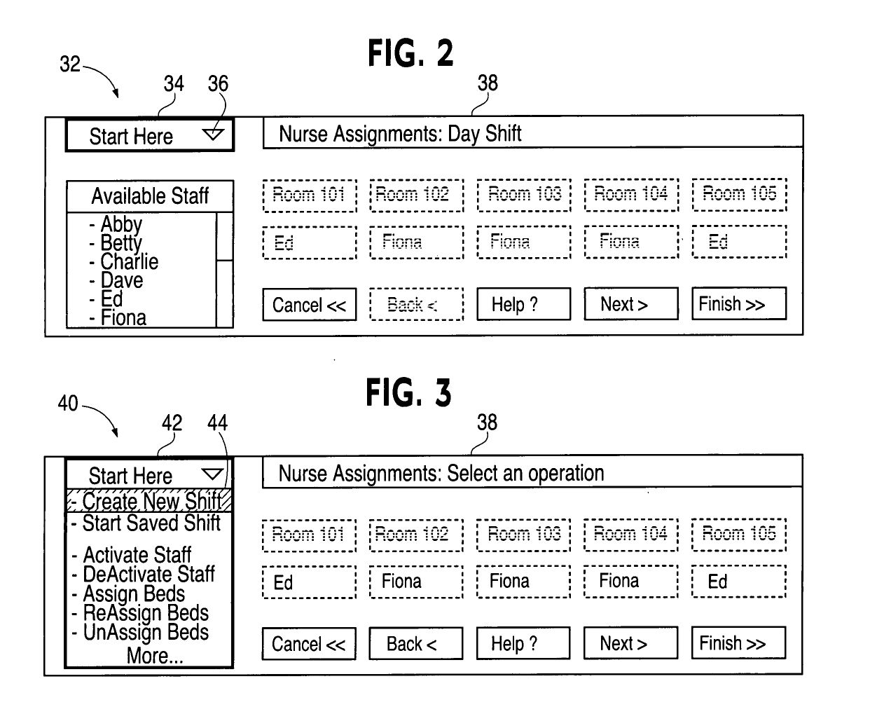

FIGS. 2 through 12 demonstrate the software using a more concrete example. The purpose of the routine in the example is to create a new nurse assignment schedule for a day shift, for example in a wing on a floor in a hospital. It may be assumed that a sequence of steps was performed prior to the running of the procedure shown, which sequence led to a call to the day shift nurse assignment routine. Such a sequence may itself use the same inventive process; the process is readily scaled and nested.

In FIG. 2, the initial screen 32 shows many of the tasks and data elements that are to be involved in the process of developing a day shift assignment. This screen 32 differs from a typical wizard in that numerous elements are shown that are not likely to be selected immediately. This large amount of information allows the user a broader view of the purpose of the activity. Of all of the information on the initial screen 32, only the START HERE button 34 with its down-arrow symbol 36 is highlighted, with the remainder of the elements given no additional emphasis. The information block 38 contains identification of the activity. Selection of the highlighted element, the START HERE button 34, by mouse click or equivalent activation process, causes the software to advance to a next state.

FIG. 3 shows the next state 40 of the example. Now the user's click on the START HERE button 34 has caused a list to open in the form of a so-called pull-down menu 42 of a style common to GUI applications. The information block 38 contains updated instructions. Hovering over the highlighted menu 42—that is, positioning a cursor on the block of interest without activating any selection keys—causes the specific entry 44 hovered over to change its appearance, if preferred, such as by changing color, providing an informational message, and the like. In the embodiment shown, clicking on an item in the menu 42 causes advancement to a next state.

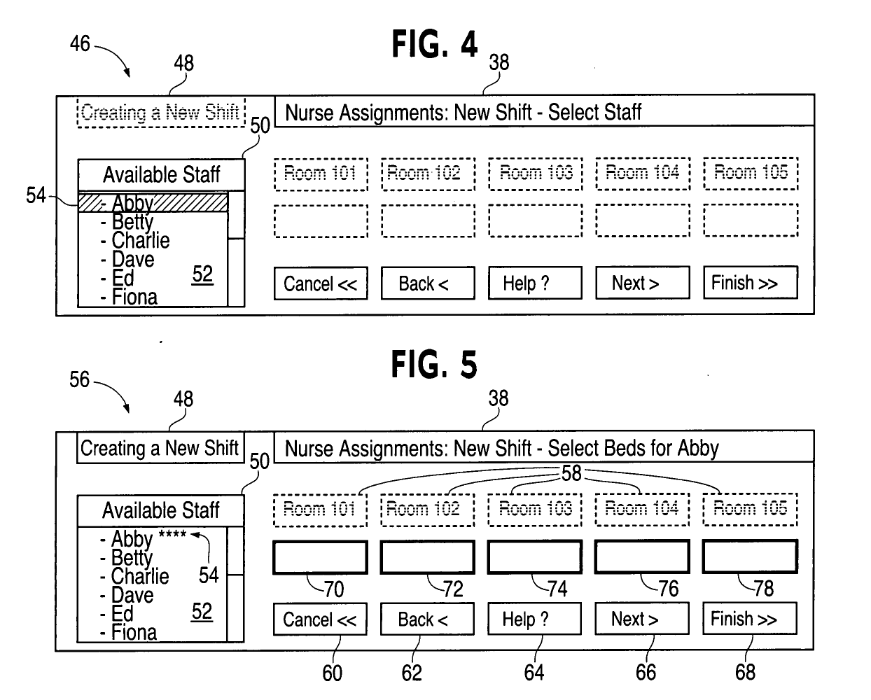

FIG. 4 shows the next state 46, in which the START HERE legend has been replaced by a CREATING A NEW SHIFT legend 48, while the information block 38 has again changed, indicating the primary function of this screen. It may be observed that the item highlighted in the AVAILABLE STAFF block 50 was displayed in FIG. 2 but was then a list element 44 within a highlighted menu 42, whereas selection from the staff list 52 below the Available Staff legend block 50 is the primary activity of the current state 46, so the legend block 50 and Staff List block 52 are now highlighted. A hovering-and-clicking process similar to that of FIG. 3 may be used to select a staff member 54, which causes advancement to a next state.

FIG. 5 shows the next state 56, in which the information block 38 is again changed, the AVAILABLE STAFF block 50 has lost its highlighting, and the element ABBY 54 within the Staff List block 52 is now distinctively marked. In the configuration shown, the room number buttons 58, the information block 38, and the CREATING A NEW SHIFT button 48 are disabled, and can be distinctively marked to indicate this condition, while the AVAILABLE STAFF button 50 may have an operational definition, and thus may be selectable, but is not highlighted. The control button row for CANCEL 60, BACK 62, HELP 64, NEXT 66, and FINISH 68 across the bottom of the display all have defined and usable meanings at this screen, but are not preferred selections, so they are enabled but are not highlighted. The assignment spots 70, 72, 74, 76, and 78 are the elements whose selection is expected, so they are highlighted. Clicking on one of the spots 70, 72, 74, 76, and 78 causes advancement to a next state.

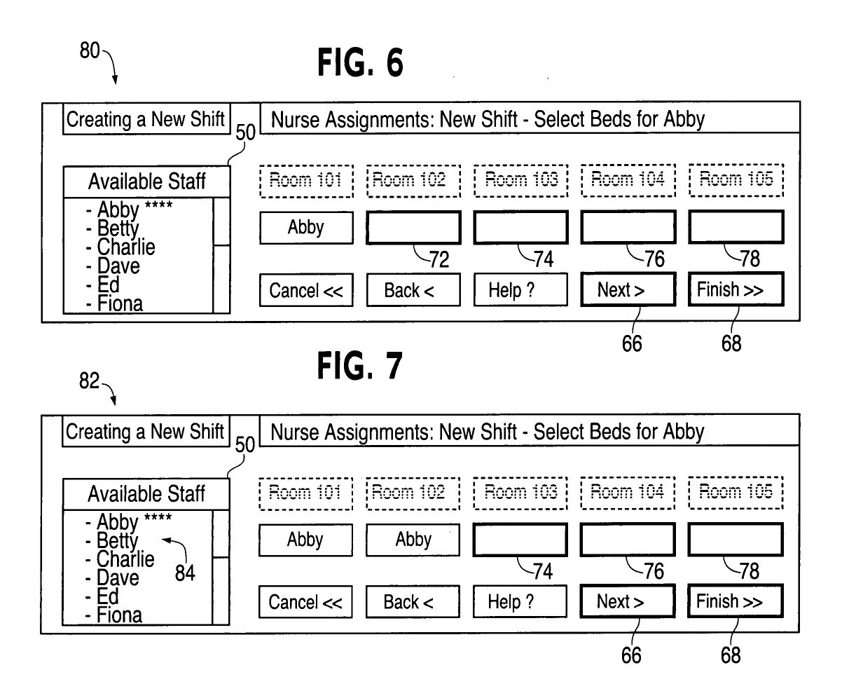

FIG. 6 shows the next state 80, in which the spot 70 has received the ABBY entry and has lost its highlighting, as it is now not expected to be selected. The remainder of the spots 72, 74, 76, and 78 are still available, and therefore still highlighted, while the NEXT button 66 and the FINISH button 68 are now highlighted as they are, in some embodiments, the preferred options in this screen. Clicking on any valid option, such as the NEXT button 66 or another spot 72, causes advancement to a next state.

FIG. 7 shows the next state 82, in which a second spot 72 has received the ABBY entry and has lost its highlighting. Here, the most likely options may be selection of another of the available spots 74, 76, and 78 and changing of the selected staff member from the Available Staff list 52.

At this point, several options are available to the programmer implementing a system with this software invention. In a first embodiment, the software can require that the user click on the NEXT button 66 or the FINISH button 68, either of which can direct the user to a next state, with the assumption that the routine is incomplete because the unselected rooms still await assignment. The FINISH button 68 can also be defined in this state as a termination, so that the remaining rooms are left unassigned and the routine is completed, in which case the program can be returned to its IDLE state 12. In a second embodiment, user selection of the unhighlighted AVAILABLE STAFF button 50 can be interpreted as an indication that selecting rooms for ABBY 54 is concluded, and, if clicked, can direct the user to a next state. Similarly, in a third embodiment, direct selection of another list element such as BETTY 84 can be used to advance, not to the immediate next state, but past it to a state beyond.

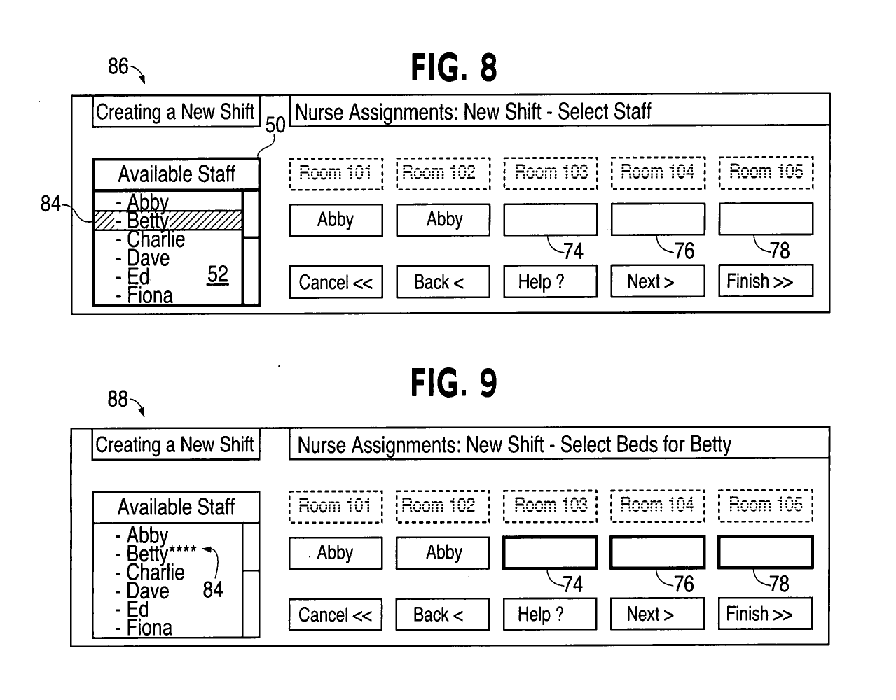

FIG. 8 shows the next state 86 after the state 82 of FIG. 7. In this state 86, the AVAILABLE STAFF button 50 is again highlighted, and no option within the list 52 has a distinctive mark signifying that a selection has been made. Clicking on any valid option, such as the item BETTY 84, causes advancement to a next state.

FIG. 9 shows a state 88 accessible from either the state 82 of FIG. 7 or the state 86 of FIG. 8. In this state 88, BETTY 84 has distinctive marking and the spots 74, 76, and 78 for the remaining unassigned rooms are highlighted. This state can be reached from the state 86 of FIG. 8 or from the state 82 of FIG. 7, as determined by user activity and as a function of programmer preference.

Further assignments can be made by similar state transitions, until a complete set of assignments has been entered, or until the operation has been terminated, either by selecting CANCEL 60 or by selecting FINISH 68 while some spot entries remain as null items. Confirmation screens can be provided to verify intent if unusual items are selected, such as, in the present example, selecting FINISH 68 while some rooms are without assigned staff.

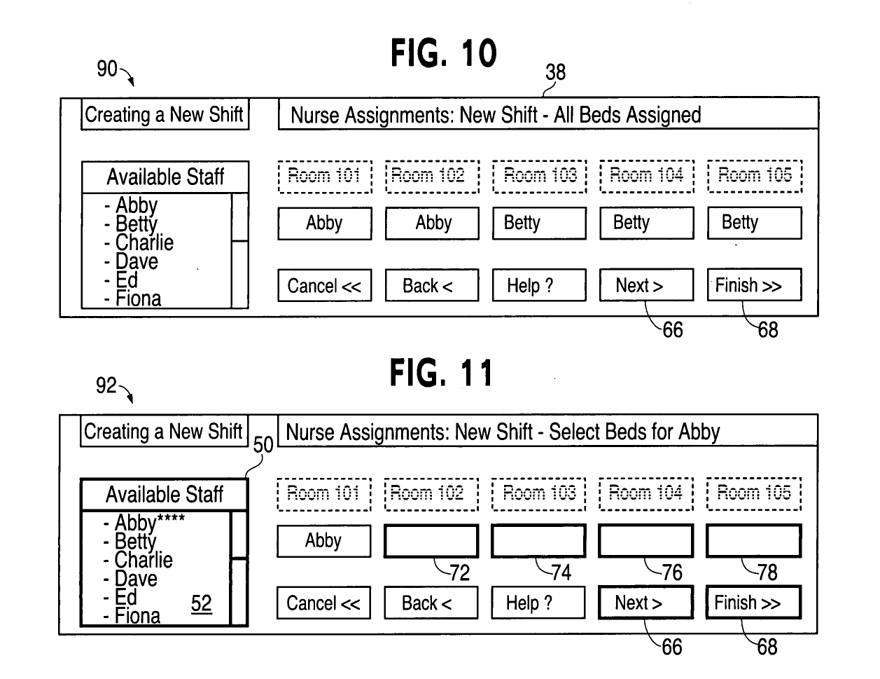

FIG. 10 shows a display 90 in which the above process has been taken to completion, so that the information block 38 indicates that the assignments for the new shift are all made. From this display, both the NEXT 66 and FINISH 68 buttons can lead to a completing state in which floor number, wing identification, date, and other items are selected from lists or directly entered by keystrokes, for example. These and other items may instead have been selected or entered in a previous routine prior to the calling of the routine described herein, which previous routine can similarly use dynamic highlighting software structure to simplify the construction of such a previous data block.

While the example used herein calls for the use of dynamic highlighting in selecting from lists and clicking on buttons only, other forms of data input or modification can benefit from this inventive approach to prompting. These forms include provision of data fields into which a user can enter data by such methods as keystroking, dragging and dropping, cutting and pasting, editing or deleting existing data, and selecting groups of list items, and the like. In addition to data fields, typical GUI functions such as check boxes, radio buttons, simulated analog functions such as slide bars, and the like can be supported. Other functions can include viewing uneditable data. Non-text data may likewise be processed using dynamic highlighting, such as selecting, cutting and pasting, or editing of icons, incorporating external files or references thereto into a present file, altering formatting, and such other functions as may be required in the performance of a user interface function.

The steps shown herein employ a basic screen to which minimal changes are applied while a significant amount of data is processed. This contrasts with common practice, for example using wizards, in which processing a similar amount of data might involve a user's being presented with a sequence of dissimilar screens, and might require that the user revisiting each of these screens several times before a task, such as the staffing of a nursing shift used in the example, was complete.

A feature of the invention herein described is the attraction of user attention to the most likely items to be chosen among or filled in during completion of a step in a data acquisition or modification procedure. This attraction of user attention may be performed in a variety of ways, such as by assigning uniform surface textures and low-intensity, medium brightness colors such as grays or blues to most fields in a screen, then assigning colors that are contrasting, whether brighter or darker, as well as assigning distinct textures and features, to the items to be preferentially noticed. Alternative methods include surrounding fields of interest with additional graphical features such as boxes, using contrasting shapes such as curves, versus square corners and straight sides, to establish field boundaries, increasing the size of fields of interest, and other ways of emphasizing elements.

GUI displays can use regions of contrasting hue or intensity to simulate a third dimension in a two-dimensional display, such as by placing narrow, lighter borders on the top and left of a rectangular region and darker borders on the bottom and right of such a region. The effect of these contrasting color borders is to create the appearance of a slightly raised pushbutton on a panel lighted from the upper left. The same effect, reversed, can create the appearance of a similarly lighted pushbutton that has been pressed. Eliminating these contrasting borders can eliminate the appearance of a button altogether, while applying a speckled effect to the border and/or any text within the region is one of several ways of symbolizing that the particular function is presently disabled. Similarly, a lighter or darker solid border line can be placed, without the above-described raised-button effect, as can a combination of lighter and darker lines entirely around a region to give the appearance of a groove. Effects such as these can also be used to define a field that is set off from the rest of a screen but does not strongly resemble an actuateable button.

Animation of the display, such as by having the fields of interest grow in size at a noticeable rate, continue to vary in size or color as though “pulsing,” or move slightly in an oscillatory fashion, for example, while somewhat more computationally intensive, can be practical in some embodiments. Typical computers used for the functions herein described are in many instances rich in processor and display capability and memory depth, and may readily support animation.

Adaptive assignment of highlighting is another feature of the present invention. In a basic embodiment incorporating the invention, the programmer selects the preferred next choices that will be highlighted for the user, relying on knowledge in the task subject matter. In some enhanced embodiments, the programmer can allow a user's preferences to alter the presentation seen by that user. For example, if a user is required to or able to furnish identity before using the software, a history of that user's preferred choices may be on record, so that the dynamic highlighting at successive points in a process may be tailored to that user's normal practice, rather than the programmer's assumptions.

Adaptive assignment can be simplified, if preferred, by retaining no stored record, and instead providing adaptive highlighting within a single session. In this embodiment, the adaptive highlighting seen at the beginning of a session can change during the session in response to a user's actions, for example by highlighting additional fields at particular steps.

Weighting of adaptive highlighting assignment can be performed within the software. For example, a first unhighlighted field that is not appropriate for selection at a specific state in a process may have a zero weighting, so that that field's selection by a user, even repeatedly, never results in highlighting of that field at that state. As a contrasting example, a second unhighlighted field, the selection of which by the user in a specific state is appropriate, may serve as an indication that the user is becoming proficient in using the software. The second field may be assigned very high weighting at that specific state in the process, so that the second field may be added to the group of highlighted fields after a small number of repetitions.

In FIG. 6, for example, the user may by default click a first spot 72 and then click NEXT 66, which may in some embodiments advance the software to the state shown in FIG. 8 and require reselecting ABBY to allow access to the state shown in FIG. 7. In contrast, clicking the first spot 72 in FIG. 6, then clicking a second spot 74 may be valid in some embodiments, and may reduce the net number of operations performed. Similarly, in FIG. 7, directly selecting BETTY 84 instead of NEXT 66 followed by AVAILABLE STAFF 50 followed by BETTY 84 is a shortcut that can save several steps and may likewise be allowed in some embodiments.

If weighted adaptive highlighting is implemented, then, as shown in FIG. 11, a screen 92 may show the AVAILABLE STAFF button 50 and the associated staff list 52 added to the highlighted fields, after the shortcut has been exercised an appropriate number of times. This change to the behavior of the software can be limited to a session, limited to an identified user and retained for that user, retained for a user for a time interval and deleted—in effect, “forgotten”—after that user has become inactive for an interval, or can otherwise be managed to support novice, improving, proficient, occasional, and error-prone users, as well as other users for whom the software is intended.

Dynamic highlight prompting may be most readily applied to computer systems intended for users who are fully able to access typical resources, including at least a video screen, a keyboard, and a mouse, as well as a sound generator. For users with reduced visual or aural acuity, range of motion, reading comprehension, and the like, the concept of dynamic highlight prompting may be nonetheless usable when appropriately adapted. For example, highlighting and grouping of preferred selection options can direct the attention of a low visual acuity or dyslexic user to options of greatest likelihood, reducing the effort required to perform standard tasks.

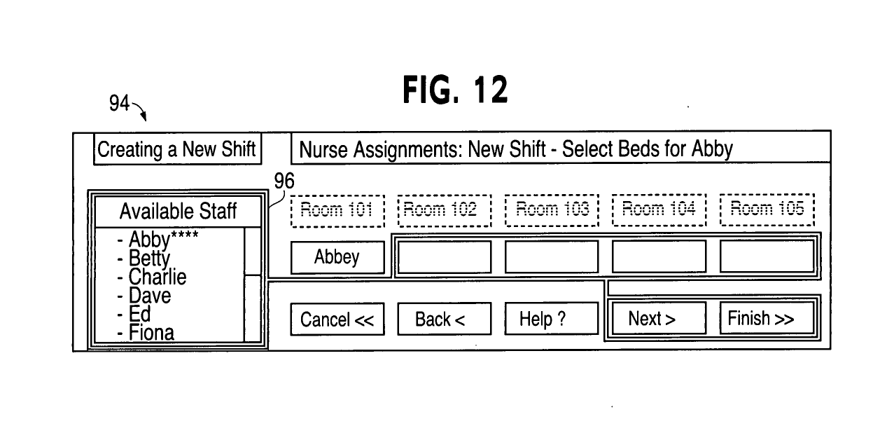

FIG. 12 shows a display 94 generally equivalent to FIG. 6, with enhanced ease of use. In this display 94 embodiment, a continuous graphical box 96 connects the group of interest, and, as may be seen from a comparison to FIG. 6, a proficient user has received a weighted adaptive highlight on the Available Staff button 50 and the associated staff list 52.

For a nonvisual user, a talking or Braille display can include audible or tactile prompts similar in function to the boxes or contrast enhancement highlighting of a visual display. For a low-mobility user, jumping to a preferred selection group may be simplified, for example, to a single sip or puff on an air-tube input. For such a user, choosing an entry within even a distributed selection group may be simplified to a sequence in which the user steps through highlighted options, pauses at a particular option, receives a visual or audible prompt from the system, and confirms the selection by responding within a time window. Similar adaptation to other functional limitations is equally possible.

Confirming identity in a privacy or security sensitive environment restricted to trusted users may be similarly enhanced by comparing a present-session pattern of use to one or more stored patterns of use from previous sessions. Such an application of adaptive dynamic highlight prompting could, for example, begin each session as though the software were not adaptive, and a pattern of shortcut use could be compared to a user's previously established behavior while the adaptive dynamic highlight prompting proceeded, in order to establish a confidence grading of the identity of the user.

Although dynamic highlight prompting as shown is useful in support of such tasks as the creation and modification of database entries by health care facilities, schools, repair shops, and other users who may be concerned with ease of use and prevention of mistakes, it can be used in many environments, such as manufacturing, warehousing, and food service, where speed and reliability may be principal considerations, as well as in military, law enforcement, courthouse, airline passenger support, and other environments where security may be a determining factor.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to that fall within the scope of the invention.

What is claimed is:

1. A method of displaying and processing information, comprising:
displaying at least two images on a display device, wherein each image is selected from the group consisting of a selectable non-preferred element, a selectable preferred element, a nonselectable element, and an informational element;
identifying within the display device the selectable non-preferred element by a first style of display element marking;
identifying within the display device the selectable preferred element by a second style of display element marking;
identifying within the display device the non-selectable element by a third style of display element marking; and
identifying within the display device the informational element by a fourth style of display element marking.

2. The method of displaying and processing information of claim 1, further comprising detecting an input action applied to at least one of the at least two display elements.

3. The method of displaying and processing information of claim 2, further comprising reporting the detecting of the input action.

4. The method of displaying and processing information of claim 3, wherein the reporting is directed to a data management process.

5. The method of displaying and processing information of claim 2, further comprising the steps of:
establishing a state sequence by which input actions result in reporting to the data management process;
defining an input action set for a state in the state sequence, wherein each input action in the input action set is an identifiable input applied to the input component of the interface device, and wherein the input corresponds to a function that is executable in the state;
identifying as a valid input action each input action included in the input action set for a state in the state sequence; and
stipulating a next state in the state sequence, to which next state transition is made in response to detecting a valid input action, wherein the next state is a state in the state sequence.

6. The method of displaying and processing information of claim 5, further comprising initializing execution of a state sequence for display and selecting information; and transitioning to a stipulated next state in the state sequence in response to detection of a valid input action.

7. The method of displaying and processing information of claim 6, further comprising interposing a confirmation request display image, wherein the interposing requires a user to verify that a nonpreferred valid input action by the user was intentional prior to executing the command associated with the valid input action.

8. The method of displaying and processing information of claim 6, further comprising:
identifying a change in the assigned display attribute of a display element, wherein the display attribute subjected to change is associated with at least one of a user, a process state, and a valid input action; and
storing the identified display element attribute change.

9. The method of displaying and processing information of claim 8, further comprising the steps of:
recalling the identified display element attribute change; and
applying the identified display element attribute change associated with at least one of a user, a process state, and a valid input action.

10. The method of displaying and processing information of claim 9, further comprising the steps of:
assigning a skill weight to a detection of a valid input action directed toward a display element within a state;
assigning a decay process for a display element within a state;
generating a weighted input preference value for the display element within the state, wherein the weighted input preference value has an initial value, decreases as a function of the assigned decay process, and increases as valid input actions are detected, wherein the rate of increase is a function of the assigned skill weight; and
changing the display attribute assignment of a display element in the action set for the state, when the weighted input preference value of the element transitions beyond a threshold level.

11. The method of displaying and processing information of claim 10, further comprising altering the display image to conform to a change in the display element attribute.

12. A computer readable medium with program instructions for displaying and processing information, comprising the instructions for:
presenting a display image on a display component of an interface device whereupon are displayed at least two display elements;
identifying within the display image a selectable non-preferred display element by a first style of display element marking;
identifying within the display image a selectable preferred display element by a second style of display element marking;
identifying within the display image a non-selectable display element by a third style of display element marking; and
identifying within the display image an informational display element by a fourth style of display element marking.

13. The computer readable medium with program instructions for displaying and processing information of claim 12, further comprising the instructions for reporting the detection and content of the input action to a data management process.

14. The computer readable medium with program instructions for displaying and processing information of claim 13, further comprising the instructions for:
establishing a state sequence by which input actions result in reporting to the data management process;
defining an input action set for a state in the state sequence, wherein each input action in the input action set is an identifiable input applied to the input component of the interface device, and wherein the input corresponds to a function that is executable in the state;
identifying as a valid input action each input action included in the input action set for a state in the state sequence; and
stipulating a next state in the state sequence to which next state transition is made in response to detecting a valid input action, wherein the next state is a state in the state sequence.

15. The computer readable medium with program instructions for displaying and processing information of claim 14, further comprising the instructions for:
initializing execution of a state sequence for display and selecting information; and
transitioning to a stipulated next state in the state sequence in response to detection of a valid input action.

16. The computer readable medium with program instructions for displaying and processing information of claim 15, further comprising interposing a confirmation request display image, wherein the interposing requires a user to verify that a nonpreferred valid input action by the user was intentional prior to executing the command associated with the valid input action.

17. The computer readable medium with program instructions for displaying and processing information of claim 12, wherein the second style of display element marking comprises changing the display characteristics of a component of a display element sufficiently to render the display element so marked readily distinguishable from display elements not so marked.

18. The computer readable medium with program instructions for displaying and processing information of claim 17, wherein the second style of display element marking comprises one of increasing the size, circumscribing, and altering the coloration of display elements so marked, so that the display elements so marked are readily distinguishable from display elements not so marked.

19. The computer readable medium with program instructions for displaying and processing information of claim 12, wherein the third style of distinctive marking comprises reducing contrast between a component of a display element and another component of the display image on the interface display device, so that the display elements so marked are readily distinguishable from display elements not so marked.

20. The computer readable medium with program instructions for displaying and processing information of claim 12, wherein the fourth style of distinctive marking comprises presenting an informational display element so that a display element so marked is readily distinguishable from display elements not so marked.

21. An information acquisition, maintenance, and display system, comprising:
a processing device;
an input/output interface unit for the processing device;
an information storage and retrieval unit providing modifiable record keeping for the processing device; and
a processor-based instruction sequence actuating the processing device to provide control of the interface unit and the information storage and retrieval unit.

22. The information acquisition, maintenance, and display system of claim 21, wherein the input/output interface unit further comprises at least one of:
a two-dimensional display output device supporting at least two distinct levels of visual intensity;
a keyboard-equivalent input device;
a device capable of providing an input indicating a location on the display area of the display output device; and
a device capable of providing, as an input, an activation signal in support of the location-indicating device.

23. The information acquisition, maintenance, and display system of claim 22, wherein the display device is capable of displaying at least one of text characters that can exhibit more than one appearance and graphical information, and wherein the display device is substantially controlled by the processing device.

24. An information acquisition, maintenance, and display system, comprising:
means for displaying, entering, selecting, and modifying data in a data management process;
means for presenting a plurality of data elements, wherein a data element has any of a plurality of values assigned to an attribute thereof, using a data display device capable of providing at least a two-dimensional display image to represent the plurality of data elements;
means for accepting input from a data input apparatus;
means for identifying, within the display image, a selectable, non-preferred display element by a first style of display element marking;
means for identifying within the display image a selectable, preferred display element by a second style of display element marking;
means for identifying within the display image a non-selectable display element by a third style of display element marking;
means for identifying within the display image an informational display element by a fourth style of display element marking; and
means for storing, modifying, and retrieving data in a data management process.

25. The information acquisition, maintenance, and display system of claim 24, further comprising:
means for detecting an action associated with at least one element of the at least two display elements;
means for reporting detection of the action; and
means for reporting any content associated with detection of the action to the data management process.

26. The information acquisition, maintenance, and display system of claim 25, further comprising:
means for establishing a state sequence by which input actions result in reporting to the data management process;
means for defining an input action set for a state in the state sequence, wherein each input action in the input action set comprises an identifiable input applied to the input component of the interface device, and wherein the input is associated with a function that is executable in the state;
means for identifying as a valid input action each input action included in the input action set for a state in the state sequence; and
means for stipulating a next state in the state sequence, wherein the identity of the next state to which transition is made after input of a valid input action is determined at least in part by the identity of the valid input action.

27. The information acquisition, maintenance, and display system of claim 26, further comprising:
means for initializing execution of a state sequence for display and selecting information; and
means for transitioning to a stipulated next state in the state sequence in response to detection of a valid input action.

28. The information acquisition, maintenance, and display system of claim 27, further comprising means for interposing a confirmation request display image, wherein the means for interposing requires a user to verify that a nonpreferred valid input action by the user was intentional prior to executing the command associated with the valid input action.

29. The information acquisition, maintenance, and display system of claim 24, further comprising means for comparing a present-session pattern of software use by an identified user to a previous-session recorded pattern of use for that user, wherein a rating of similarity between user patterns of use between sessions provides a rating of confidence in the identity of that user.
